(19) United States
(12) Patent Application Publication
(10) Pub. No.: US 2019/0059340 A1
(43) Pub. Date: Feb. 28, 2019

(54) Edge-Lit Laminated Aquarium Wall and Filtration Assembly

(71) Applicant: Joshua Douglas Brown, Chester, VA (US)

(72) Inventor: Joshua Douglas Brown, Chester, VA (US)

(21) Appl. No.: 15/691,742

(22) Filed: Aug. 31, 2017

(51) Int. Cl. A01K 63/06; A01K 63/00; F21V 31/00; H05B 33/08; H05B 37/02; F21V 3/04

(52) U.S. Cl. CPC A01K 63/06; A01K 63/003; F21V 31/005; F21Y 2103/10; H05B 37/0281; F21V 3/0445; H05B 33/0845

(57) ABSTRACT

A waterproof, edge-lit laminated aquarium wall and filtration assembly which provides a visual illusion replicating the depth, color, scenery, and gradient found in a naturally lit underwater environment—while also providing an inlet, outlet, and framework to facilitate the function of a multistage water filtration system.

### CROSS-REFERENCE TO RELATED APPLICATION

This application claims the benefit of provisional patent application Ser. No. 62/381,211, filed on Aug. 30, 2016 by the present inventor, and is hereby expressly incorporated by reference in its entirety.

### FIELD OF THE INVENTION

This invention relates to aquariums. More specifically invention relates to the visual qualities of the background of an aquarium as well as the functionality of an integral water flow and filtration system.

### BACKGROUND OF THE INVENTION

To date, hobbyists in both the freshwater and saltwater aquarium industry have certain options available to them when it comes to the design and visual appearance of the background of an aquarium. Most common aquariums are manufactured and sold with a rear wall that is comprised of a single transparent clear sheet of glass, plastic, or acrylic. Others have a rear wall that is painted or colored an opaque shade of blue or black. For this reason, there exists numerous aftermarket print media backgrounds displaying static artwork of aquatic environments, which can be affixed to the external side of the rear wall of an aquarium. Likewise, many aquarists have thus resorted to do-it-yourself projects—painting their own backgrounds or creating their own artwork to display behind the rear wall of their aquarium. Some aquarists have even attempted projects that re-create the appearance of a natural underwater scene by building various types of shadowboxes behind the back wall of their aquarium. While the specific design and colors used in the do-it-yourself shadowboxes varies for each individual project, it is always comprised of a box with a semi-transparent anterior wall, an opaque posterior wall, with a void space between the two, and perimeter lighting—the combination of which can give an illusion of depth when viewed from the front.

Additionally, some aquarium manufacturers utilize an intermediate rear wall, (generally an opaque black or blue in color) which appears as the background of the aquarium when viewed. The intermediate wall has an inlet and outlet so as to create a hidden and integral compartment in the rear of the aquarium utilized to house filtration media and various equipment used in the trade for maintaining water parameters such as heaters, water pumps, protein skimmers, or UV sterilizers.

While all of the aforementioned listed options inherently have varying levels of beauty, realism, and function—they also each have limitations and shortfalls. Shadowbox aquarium backgrounds and printed artwork backgrounds in existence often achieve a unique level of realism and beauty, but make no provision for water flow or incorporating filtration plumbing and equipment. The aquariums with intermediate rear walls and built-in filter systems provide unparalleled convenience in maintaining water parameters and hiding equipment, but lack depth and realism in their appearance.

There is currently nothing in existence that has the ability to provide the viewer with both a background that imitates the illusion and depth of a naturally lit underwater scene when viewing the aquarium from the front while also serving as an intermediate wall inside of the aquarium providing an inlet and outlet for an integral filtration system and thus hiding the previously mentioned plumbing and equipment.

### SUMMARY OF THE INVENTION

The subject invention is a waterproof, edge-lit laminated aquarium wall and filtration assembly which accomplishes a dual purpose of providing a visual illusion that replicates the depth, color, scenery, and gradient found in a naturally lit underwater environment—while also providing an inlet, outlet, and framework to facilitate the function of a multistage water filtration system. It is conceived to achieve both stated purposes, while having compatibility in various modes of application and can either be manufactured into the structure of a new aquarium or retrofitted into a pre-existing one.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1—Perspective Side View of Components of the Edge-lit Aquarium Wall Assembly

FIG. 2—Exploded Side View of Components of the Edge-lit Aquarium Wall Assembly

FIG. 3—Perspective Front View of Components of the Edge-lit Aquarium Wall Assembly

FIG. 4—Perspective Side View of the Assembled Edge-lit Laminated Aquarium Wall

FIG. 5—Exploded Side View of the Assembled Edge-lit Laminated Aquarium Wall

FIG. 6—Perspective Front View of the Assembled Edge-lit Laminated Aquarium Wall

FIG. 7—Perspective Front View of Edge-lit Wall Assembly with Filtration Framework

FIG. 8—Perspective Rear View of Edge-lit Wall Assembly with Filtration Framework

FIG. 9—Perspective Front View of Edge-lit Wall Assembly in All-in-One Aquarium

FIG. 10—Perspective Rear View of Edge-lit Wall Assembly in All-in-One Aquarium

FIG. 11—Perspective Front View of Edge-lit Wall Assembly with Integrated Artwork

FIG. 12—Perspective Rear View of Edge-lit Wall Assembly with Add-On Equipment

FIG. 13—Perspective Front View of Edge-lit Wall Assembly in Hang-on-Back Filter

FIG. 14—Perspective Rear View of Edge-lit Wall Assembly in Hang-on-Back Filter

FIG. 15—Perspective Front View of Edge-lit Wall Assembly with Plumbing to Sump

FIG. 16—Perspective Rear View of Edge-lit Wall Assembly with Plumbing to Sump

### DETAILED DESCRIPTION OF THE INVENTION

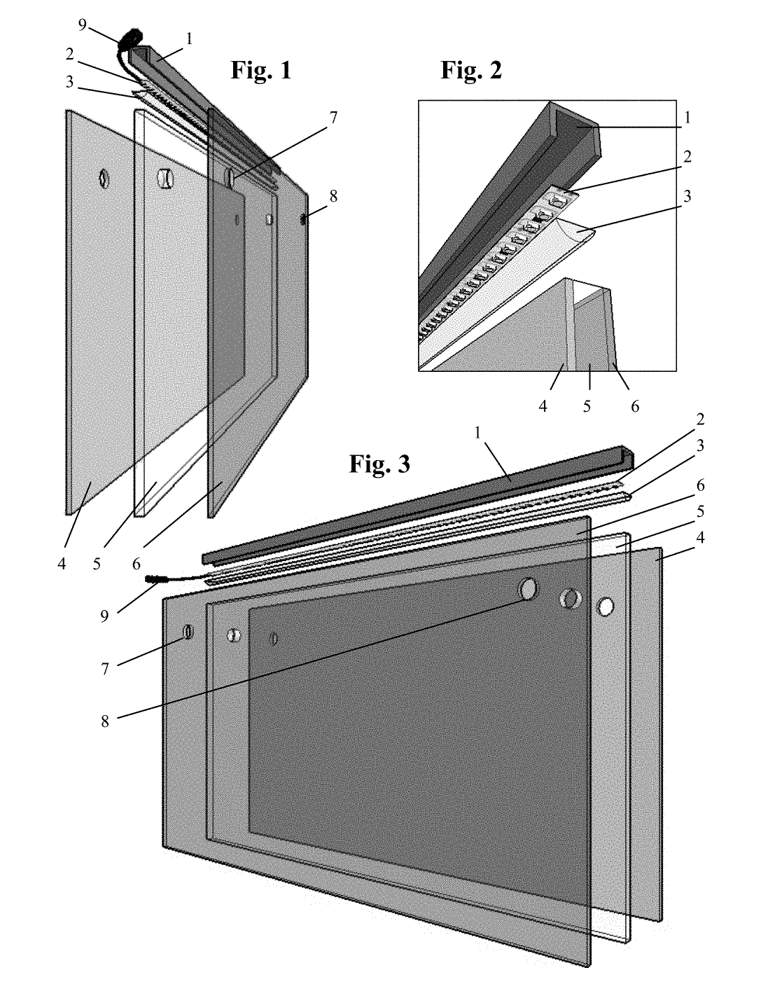

Referring now to the invention in more detail, in FIGS. 1-3 there is shown the individual components used for the assembly of the edge-lit, laminated aquarium wall and filtration Unit. At the top of the barrier wall is mounted a U-Channel or C-Channel type aluminum frame (1) which serves as a heat sink and conceals a light emitting diode (LED) strip (2) enclosed within. The width of the channel in the aluminum frame (1) is between ½″ and 2″ inches respectively and is determined by the volume in gallons and height of the aquarium for which it is designed. Whereas the length of the aquarium determines the overall length of the aluminum channel (1) utilized. The thickness of the aluminum channel (1) should be approximately 1/16″ to ¼″ inches thick and should allow the heat from the LED strip (2) below to evenly dissipate into the surrounding air without becoming so hot to the touch as to burn a person's skin.

A flexible or semi-rigid strip (2) consisting of 12 volt direct current (DC) power 5050, 5630, or 7020 chip type light emitting diodes (LEDs) is mounted to the underside of the aluminum channel (1) and is directed downward to illuminate the laminated wall (4, 5, 6) beneath. The basic colors and spectrum of the LED strip (2) used is a combination of blue LED chips rated from 440-460 nanometers (nm) color and white LED chips rated from 6000-12000 kelvin (k) light temperature. However, multi-color red/green/blue (RGB) LED strips may also be used in combination with an in-line LED controller or timer module. This feature allows the user dynamic customization of the colors, hue, intensity, and lighting schedule of the LED strip (2).

The top metal frame (1) and lighting strip (2) are permanently sealed and affixed to the barrier wall (4, 5, 6) described below utilizing a permanent, clear type of aquarium safe silicone adhesive (3). The silicone sealant/adhesive (3) provides a ultra-violet (UV) resistant, optically clear medium, through which the LEDs transmit light when powered on. The silicone (3) also provides thermal protection for the barrier wall beneath and waterproofs the electrical circuitry, diode chips, and wires of the LED strip (2) above. A direct current (DC) connector plug (9) for the means of applying electricity is wired to the terminals on the edge of the LED strip (2) and protrudes out of the aluminum channel (1) through a small opening, which is also waterproofed by the silicone barrier (3).

The core of the laminated wall is comprised of three principle layers (4, 5, 6) of differing characteristics permanently bonded to form a single and solid wall which is submersible and can not be penetrated by water. The rear layer is a acrylic sheet between ⅛″ and ¼″ inches thick and is a shade of opaque light to medium blue (4). The opaque color characteristic of this rear layer (4) provides the initial backdrop of the illusion and visual effect as the light reflected will be predominantly in the blue spectrum. It is this quality which also makes anything installed behind the rear wall (4) hidden from sight when viewing the laminated wall assembly from the front. The rear layer (4) can also have artwork or graphics (20) of underwater scenery applied onto it's inward facing side.

The middle layer is a thicker cell cast acrylic sheet between ¼″ and 1½″ inches thick and is optically clear (5). The middle layer of acrylic (5) provides the rigid structural strength of the unit to resist warping or bowing as it is exposed to long-term pressure from the water in an aquarium. Before joining the layers of the assembly together, the outside faces of the middle layer (5) are sanded with fine grit sandpaper in such a way to give the clear acrylic sheet translucent light transmission properties—giving it a frosted or hazed appearance. This will cause the majority of light waves directed into the wall assembly, (4, 5, 6) from the LED strip (2) above, to remain within the laminated layers—producing an illuminated gradient from the top down similar in appearance to moonlit or sunlit water. It wall also diffuse and blur the details of any graphics or artwork (20) applied to the rear layer (4) when viewed from the front.

The front layer is an acrylic sheet between ⅛″ and ¼″ inches thick and with a semi-transparent tint of blue or green (6). The semi-transparency and tint of the front layer (6) allows external lighting from ceiling fixtures or main display area aquarium lights to compliment the effect rather than wash it out. It accomplishes this by absorbing and diffusing the white spectrum of most common external light fixtures that would be encountered, yet remains transparent enough for the user to still appreciate the illusion of depth, scenery, and blue colors of the illuminated background assembly.

The cut length and height of the three acrylic sheets (4,5, & 6) are to be equal with one another, but are determined by the overall dimensions of the aquarium in which the unit will be installed. Prior to bonding, two holes (7, 8) are drilled in the corners being aligned through all 3 sheets to provide the mounting locations for filter inlet and outlet fixtures. The placement of a filtration inlet (7) and outlet (8) hole should be adjacent to the top corners of the unit approximately 1″-2″ below the aluminum frame (1) so as not to hinder the visual effect or create shadows in the central viewing area of the aquarium background. If mounting bulkheads into the holes, they should be sized between ⅞″ and 2½″ inches in diameter each and determined by the volume and flow capacity needed for the specific aquarium and filter application. An alternative to drilling holes would be to use a router to cut two sets of smaller, hollow channels through the opposing corners of all three sheets, creating a water inlet and outlet without the need for external fixtures. The three layers of acrylic (4,5, & 6) are then permanently welded face-to-face with a clear acrylic solvent cement to form a single, solid laminate sheet that is submersible and cannot be penetrated by water.

It is imperative, however, that the faces of the three layers (4, 5, 6) are not bonded by applying solvent or heat across the entire surface area of the face. This would cause the middle layer (5) to lose its translucent properties and become completely transparent, thus degrading the illusion of depth. It could also potentially damage any artwork or graphics (20) applied to the inward side of the rear layer (4). It is therefor critical that the three sheets of acrylic are welded only along the entirety of the outer perimeter. The inlet (7) and outlet (8) are also waterproofed by being welded together around the circumference of the holes so as to allow water to pass through the holes, but never in-between or within the layers of the laminated wall assembly.

When illuminated and viewed from the front, the combination of these layers gives an illusion of depth and effectively imitates the appearance of being underwater. The varying shades of blue or green acrylic chosen for the front and rear layers (4, 6), along with the varying chip types and spectrums of LEDs (2) chosen in the design of each edge-lit wall assembly can be modified to re-create the varying hues of water found in different natural aquatic environments. For example, the water in most freshwater rivers and lakes have a green hue while the water in most saltwater reefs have a blue hue. The painted artwork or application of printed graphics (20) on the inward side of the rear layer (4) can also be used to customize the look of each individual edge-lit aquarium wall assembly and may also be used to replicate different natural aquatic scenes and environments. For example, graphics of driftwood or river rocks may be used for freshwater aquariums, while graphics of a coral reef may be used for saltwater aquariums. This feature could also be used to incorporate custom business logos, elements from photographs, or other desirable scenery such as a shipwreck, sunken ruins, and the like into the background illusion of the edge-lit wall assembly. It should also be noted, that while this specification details the assembly of the edge-lit laminated aquarium wall utilizing acrylic sheets, that the use of glass sheets is also possible. Acrylic was chosen as the primary method of creating the structure of the laminated wall assembly as the various colors and thicknesses needed were more readily available and because the tooling requirements for manufacturing it from acrylic was more feasible.

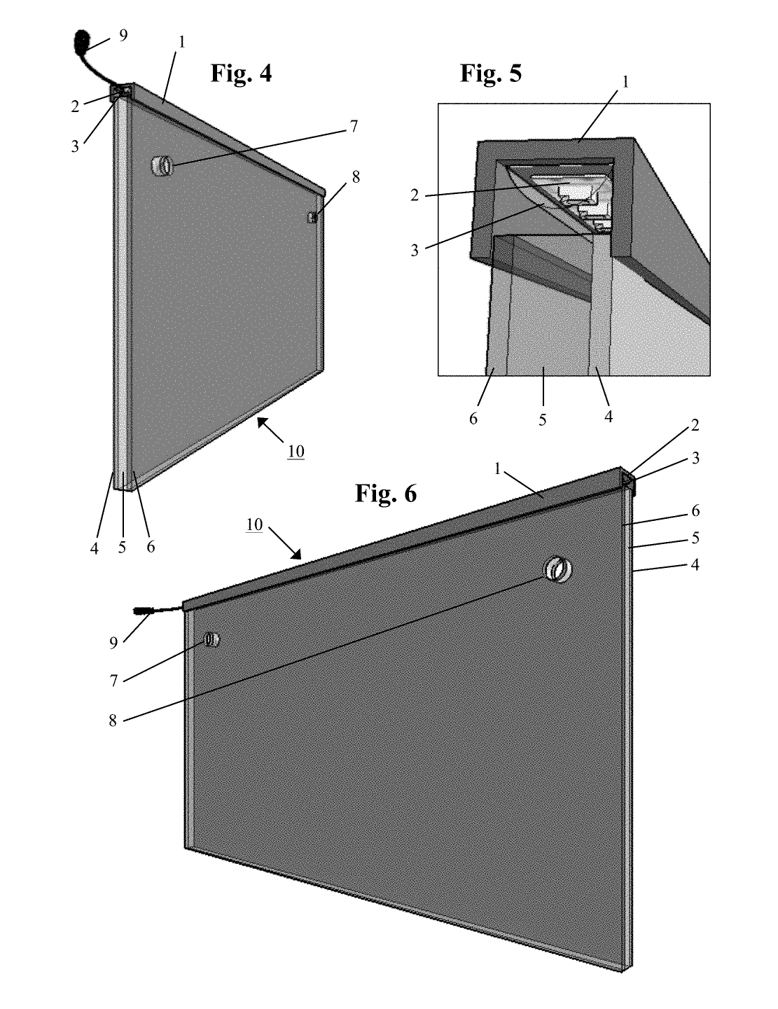

FIGS. 4-6 demonstrate the edge-lit laminated aquarium wall and filter assembly in its completed fundamental form. Beginning in FIG. 4, an underlined number ten (10) will now be used to reference the whole of the edge-lit laminated aquarium wall and filter assembly. The composition and components described in the previous paragraphs will thus remain uniform throughout the further listed various embodiments.

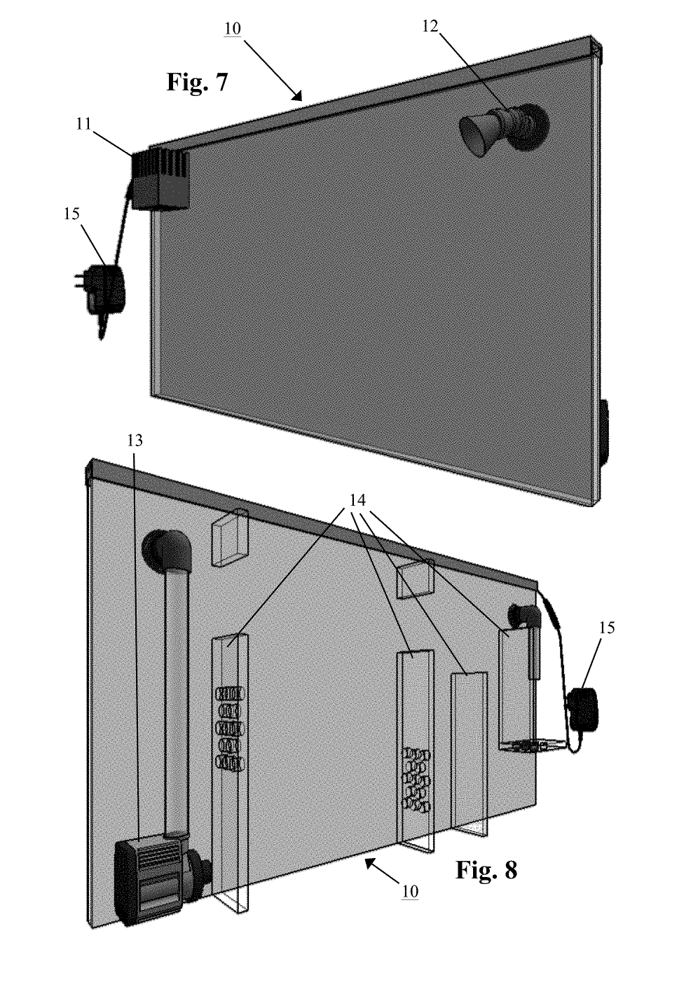

The first and primary embodiment of the edge-lit laminated aquarium wall and filter assembly is shown in FIGS. 7-12, wherein its mode of application is serving as a barrier wall for an all-in-one style aquarium with integral multistage filter.

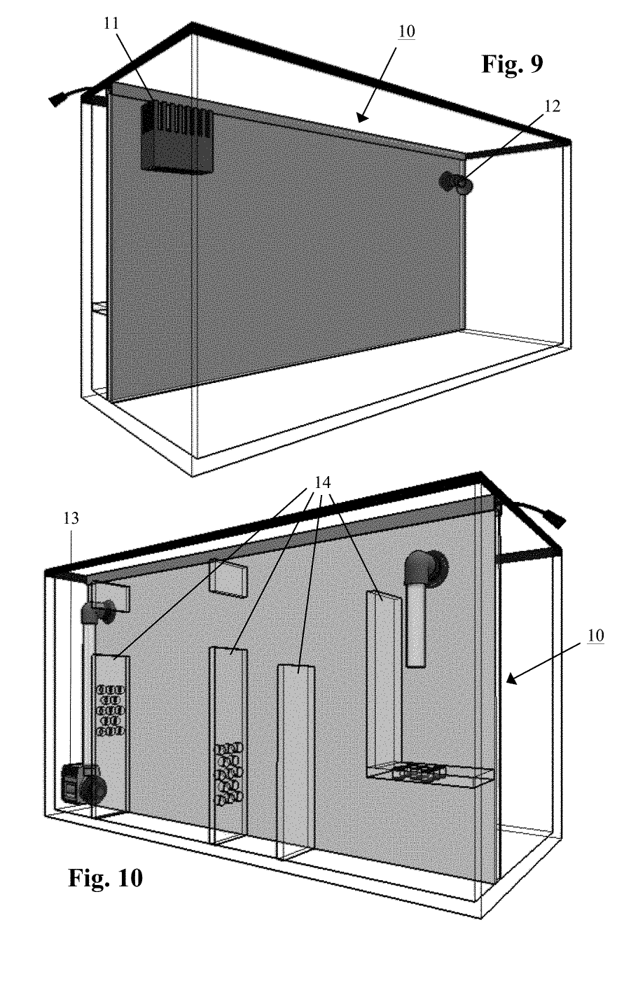

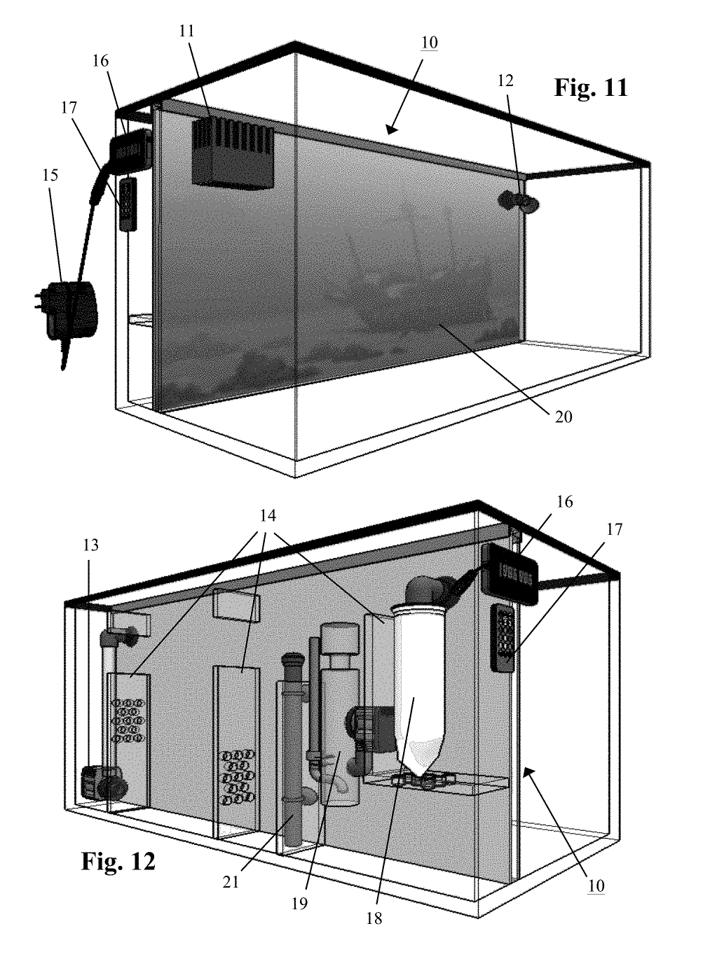

In this mode, the edge-lit laminated aquarium wall and filter assembly (10) is installed inside the rear portion of standard box shaped aquarium—being adjacent and parallel to the back wall so as to create a compartment between the two. This compartment will thus be utilized to create a built-in multistage filter. FIGS. 7-8 illustrate the additional required parts to build this embodiment prior to being installed into an aquarium. Namely, an acrylic overflow box (11) is mounted to the front of the inlet hole (7) having teeth which act as a mechanical pre-filter, preventing large debris or fish from passing into the filter—while allowing the water and small waste particulate near the surface in the display area to flow, via gravity, into the built-in filter compartments behind. A framework and series of vertical and horizontal (14) acrylic channels are then welded onto the rear facing side of the edge-lit wall assembly (10) and are strategically placed to provide the user with a highly adaptable framework of compartments for the various types of media, equipment, and filtration methods used in the aquarium hobby. The vertical and horizontal channels (14) are also placed in such a way as to prevent water from overflowing out of the aquarium during mechanical or electrical water pump failures. The first stage of the acrylic channels (14) provides a designated compartment for a sponge or filter sock (18) to complete mechanical filtration of smaller particles. The second stage (14) allows the aquarist to place various types of equipment such as a submersible heater (21), UV sterilizer, or protein skimmer (19) in the rear compartments (14) hidden from sight when viewing the aquarium from the front. The third stage provides space for sufficient chemical or biological media as determined by the user or to be used as algae based filter known as a refugium. And the final stage provides a return water pump (13), which is connected to a post-filtration water flow nozzle (12) installed in the outlet hole (8) on the front side of the edge-lit laminated assembly wall. FIGS. 9-10 show the edge-lit laminated aquarium wall assembly (10) installed inside the rear portion of standard box shaped aquarium having a base and four walls and providing the framework for the previously described integral multistage filter. FIGS. 11-12 show the ideal embodiment of the edge-lit laminated aquarium wall assembly (10)—having the addition of graphic artwork (20) applied to the inner facing side of the rear layer in the wall assembly, an in-line automated LED timer (16) with wireless remote control (17), and utilizing a dual channel RGB 5050 chip LED strip. The industry standard color codes for the chosen rear opaque blue layer (4) of the wall assembly (10) is number 2648 and the color code for the front transparent blue layer (6) of the wall assembly (10) is number 2069.

In this mode, the wall assembly also acts as a visual barrier—preventing light from the LED strip (2) or the main display light fixture of the aquarium from saturating the described built-in filter compartments (14). Additionally, FIGS. 7-8 display an alternating current (AC) to direct current (DC) power supply adapter (15) of the appropriate voltage rating and plug size connected to the external DC plug (9) of the LED Strip (2). While the AC/DC power supply adapter (15) is not pictured in most of the remaining drawings, please not that it is always necessary to illuminate the LED strip (2) and should be considered an inherent component in all of the listed embodiments.

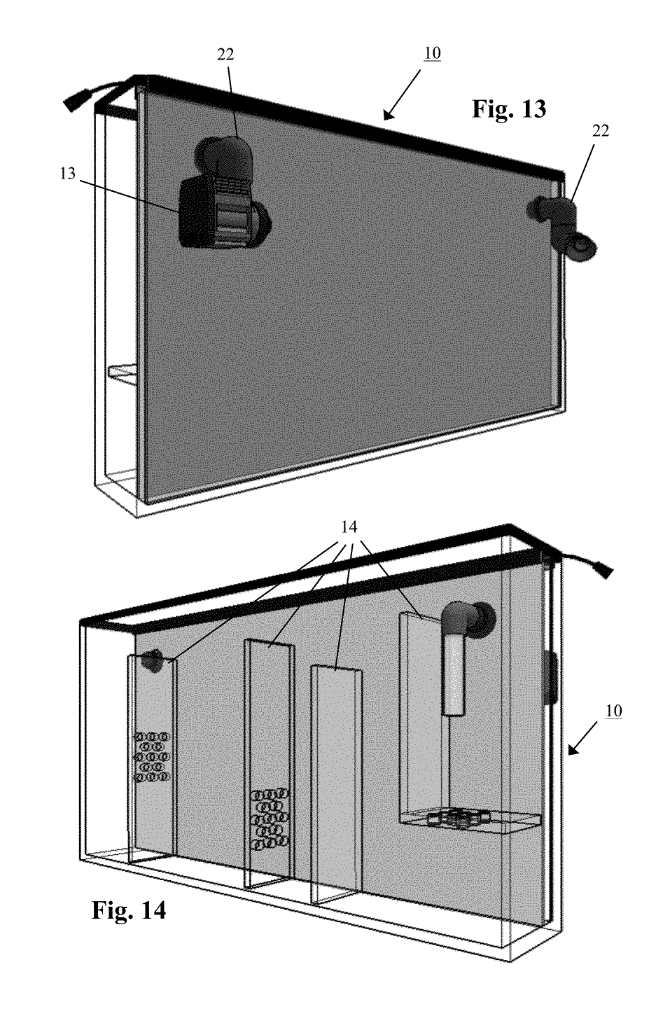

The second embodiment of the edge-lit laminated aquarium wall and filter assembly (10) is shown in FIGS. 13-14, wherein its mode of application is serving as the front wall for a hang-on-back filter unit. In this mode, the assembly is built almost identically to the first embodiment. The major difference being that a set of 90 degree polyvinyl chloride (PVC) elbows (22) are installed onto the front of the inlet (7) and outlet (8) holes. The PVC elbows (22) provide an enclosed channel for water to flow into and out of the aquarium—through external hang-on-back filter assembly. And they also provide a mounting option for hanging the elbows over the top of the rear wall of a standard box type aquarium having a base and four walls. In this configuration, the water level in the hang-on-back filter sits above the water level of the aquarium. Thus the outlet hole (8) and flow nozzle (12) directs water back into the aquarium display via gravity, while a water pump (13) is attached to the plumbing of the inlet hole (7). A base and four walls is welded around the edge-lit laminated wall assembly (10) and the framework of channels (14) that comprise the completed structure.

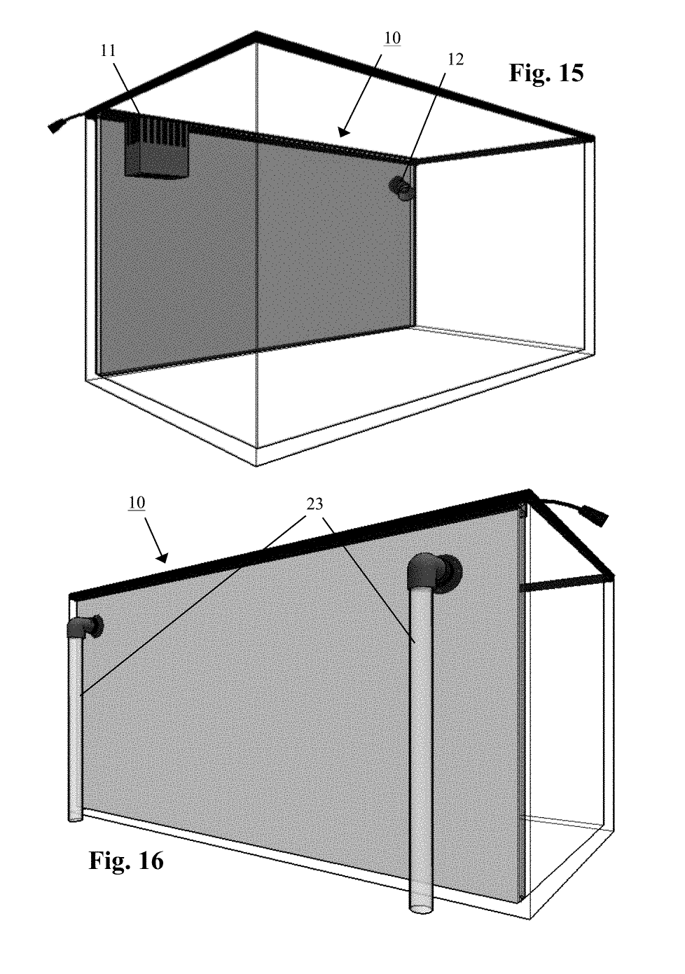

The third embodiment of the edge-lit laminated aquarium wall and filter assembly is shown in FIGS. 15-16, wherein its mode of application is serving as the rear wall in a standard aquarium box shaped aquarium with plumbing to an external sump type filter. In this mode, the assembly is also built very similar to the first embodiment. The major difference being that there is no need for an integral filter as an external sump type filter is being used. Thus the framework of acrylic vertical and horizontal channels (14) is replaced by enclosed PVC plumbing lines (23), which provided a means for channeling water to and from the external sump filter. An acrylic overflow box (11) is again utilized as a gravity fed pre-filter and is mounted to the front of the inlet hole (7) on the wall assembly (10). And a direction adjustable flow nozzle (12) is again mounted to the front of the outlet hole of the wall assembly (10).

As previously stated, the illuminated barrier wall and filtration insert unit is designed so that it can either be manufactured into the assembly of a new aquarium or retrofitted into a pre-existing aquarium. While my above description contains specificity, these should not be construed as limitations on the scope, but rather as an exemplification of the possible variations of the embodiments listed.

What is claimed is:

1. An edge-lit aquarium wall assembly unit comprising:
a. a solid, laminated wall constructed of three permanently bonded layers: a rear opaque layer in a shade of light to medium blue, a rigid middle layer that is translucent and colorless, and a front transparent layer with a blue or green tint
whereby said laminated wall is impervious to water damage when submerged
b. a waterproof strip of light emitting diodes sealed along the full length of the top edge of said laminate wall including appropriate wires, circuitry and power supply for illuminating said diodes and transmission of light into the structure
c. a channel type metal frame mounted on top of said light strip for enclosing the lighting effect and to facilitate heat dissipation away from said wall assembly
d. an inlet hole and outlet hole penetrating the structure near the top corners allowing for the passage of water through but not into said wall assembly
e. a framework of channels affixed on the rear of said wall assembly to provide means for directing the flow of water from said inlet hole, through a user defined multi-stage filter, to said outlet hole and into the front aquarium display area
whereby said wall assembly, when lit, produces a visual illusion of depth, color, and lighting gradient in the background of the aquarium being viewed from the front, that effectively simulates the appearance of viewing a natural underwater scene.

2. An edge-lit aquarium wall assembly according to claim 1, wherein the inward facing side of said rear blue opaque wall further includes the application of artwork or graphics depicting scenes found in natural saltwater or freshwater environments

3. An edge-lit laminated aquarium wall assembly according to claim 1, wherein the color and chip configuration of said waterproof light strip is composed of a combination of red, green, and blue dimmable light emitting diodes

4. An edge-lit aquarium wall assembly according to claim 1, wherein the wiring of said light strip and power supply provide means to be used in conjunction with a multi-channel in-line lighting control module or timer allowing dynamic adjustment of intensities, hues, and schedules to replicate natural day and night cycles

5. An edge-lit aquarium wall assembly according to claim 1, designed to be inserted inside the rear portion of a standard aquarium, which has a base and four wall panels, adjacent to and parallel with the back wall to serve as a visual and physical barrier separating an integral multi-stage filter compartment

6. An edge-lit aquarium wall assembly unit according to claim 1, designed to serve as the structural back wall of an aquarium with the inlet, outlet, and enclosed channels providing means for directing water flow into and out of an external sump type filter

7. An edge-lit aquarium wall assembly unit designed according to claim 1, designed to serve as the front wall of a hang on back style external filter which is mounted upon the back wall of an existing aquarium
